(19) United States
(12) Patent Application Publication
(10) Pub. No.: US 2016/0182702 A1
(43) Pub. Date: Jun. 23, 2016

(54) PHYSICAL COMPONENT DETECTION AND USER INTERFACE CHANGE ON A COMMUNICATION DEVICE

(71) Applicants: Ilan Abehassera, New York, NY (US); Etienne Castanie, Tours (FR); Jocelyn Masserot, New York, NY (US); Dan Attali, New York, NY (US); Olivier Costier, New York, NY (US); Nellie Alimi, San Francisco, CA (US)

(72) Inventors: Ilan Abehassera, New York, NY (US); Etienne Castanie, Tours (FR); Jocelyn Masserot, New York, NY (US); Dan Attali, New York, NY (US); Olivier Costier, New York, NY (US); Nellie Alimi, San Francisco, CA (US)

(21) Appl. No.: 14/578,344

(22) Filed: Dec. 20, 2014

(51) Int. Cl. H04M 1/725; H04M 1/02

(52) U.S. Cl. CPC H04M 1/7253; H04M 1/0254; H04M 1/0266

(57) ABSTRACT

A device and a method are disclosed including a mobile computing and/or communication device having an external part, such as a protective or back cover, that is detected by the mobile device. In response to detecting a change in the external part, the mobile device automatically changes the UI. Such UI changes may include changing a color scheme, fonts, display themes, different sets of icons and/or apps, user preferences, or any other pre-determined UI changes.

### TECHNICAL FIELD

This application relates generally to user interface on communication devices. More specifically, this application relates to detecting a change in a physical component, such as a cover, on a communication device and changing the User Interface (UI) accordingly.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example integrated communication and/or computing device having a base unit and a mobile unit, usable in the network computing environment of FIG. 1; and

FIGS. 4A-4D show examples of various detection techniques and mechanisms usable with the integrated communication device of FIG. 3 to detect a change of a cover component.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references mobile communication devices and covers, it will be appreciated that the disclosure may be used with other types of computing devices and equipment, such as walkie talkies, desktop and laptop computers, and printers, and to detect other types of parts such as keyboards, mouse, screen protectors, and the like.

Briefly described, a device and a method are disclosed including a mobile computing and/or communication device having an external part, such as a protective or back cover, that is detected by the mobile device. In response to detecting a change in the external part, the mobile device automatically changes the UI. Such UI changes may include changing a color scheme, fonts, display themes, different sets of icons and/or apps (small software applications), user preferences, or any other pre-determined UI changes.

With the ubiquity of computing and communication devices and users' internet access, there is an ever increasing demand for expanded services and functionalities. Much of the functionality is embedded in the apps that the users can install on their mobile devices, such as their mobile phones. In this commercial environment, the communication devices are also becoming very similar, lacking personal distinctions of any note. Having external components that may be added to or exchanged on the communication device, such as a back cover, may also add some functionalities or advantages, or enhance esthetics and add personal distinction. If the communication device can sense the component added or exchanged and react accordingly in response, then this presents another technique for adding or enhancing functionality.

### Illustrative Operating Environment

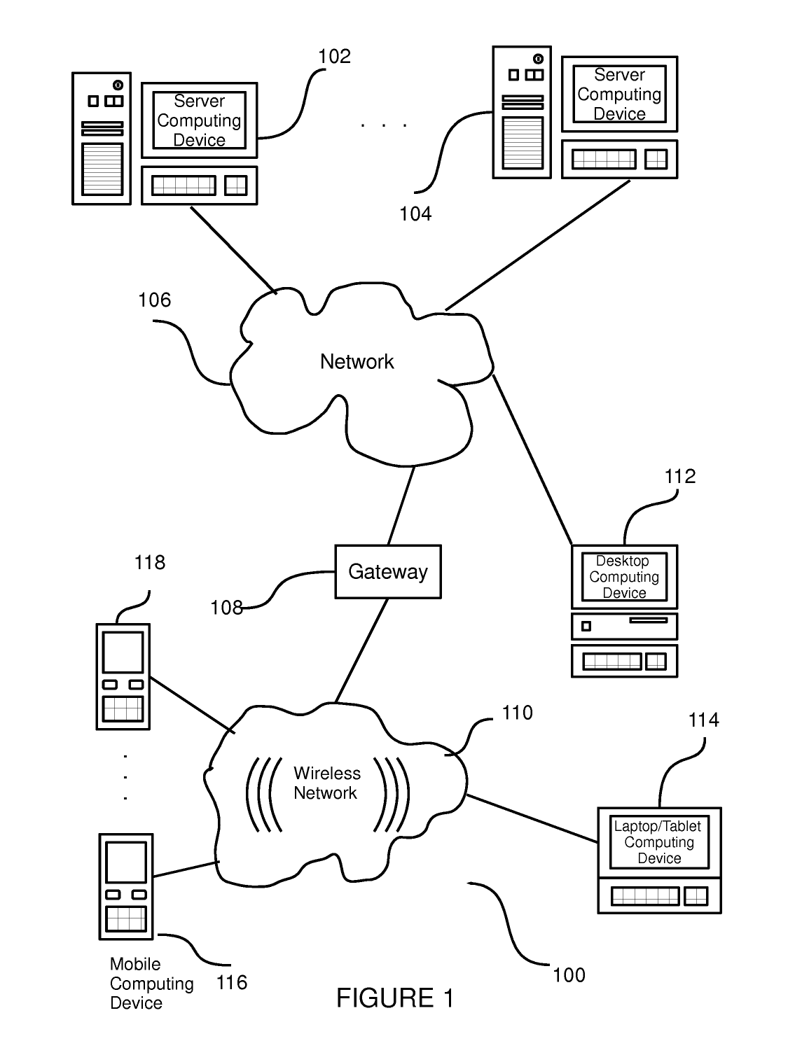

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

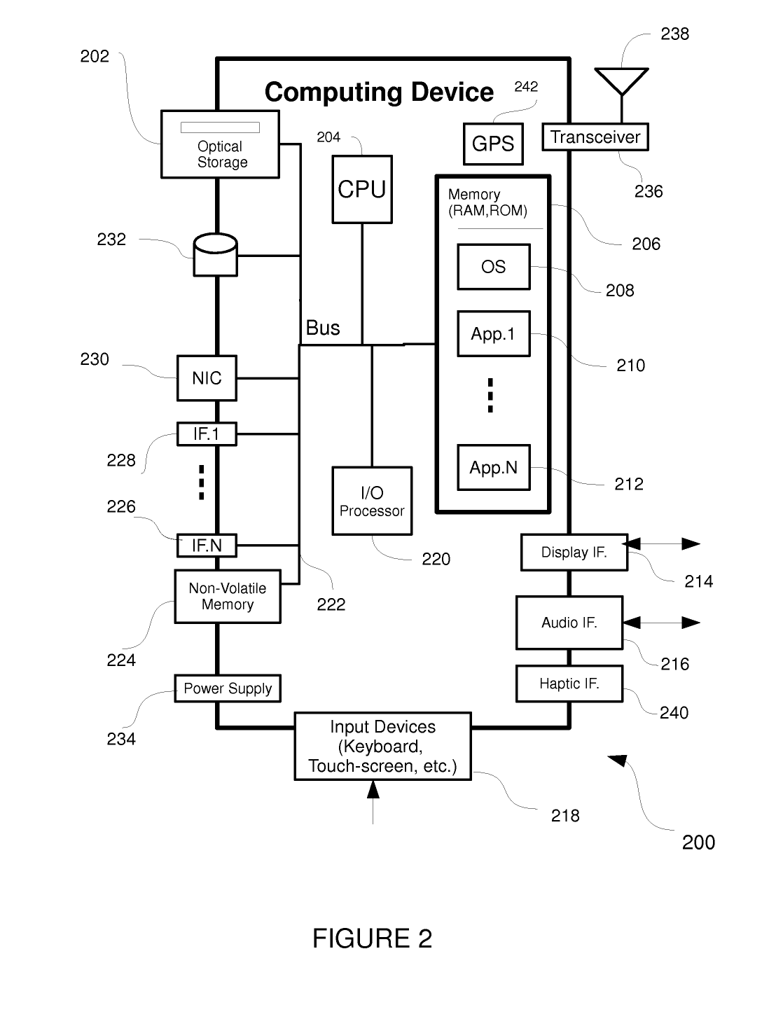

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

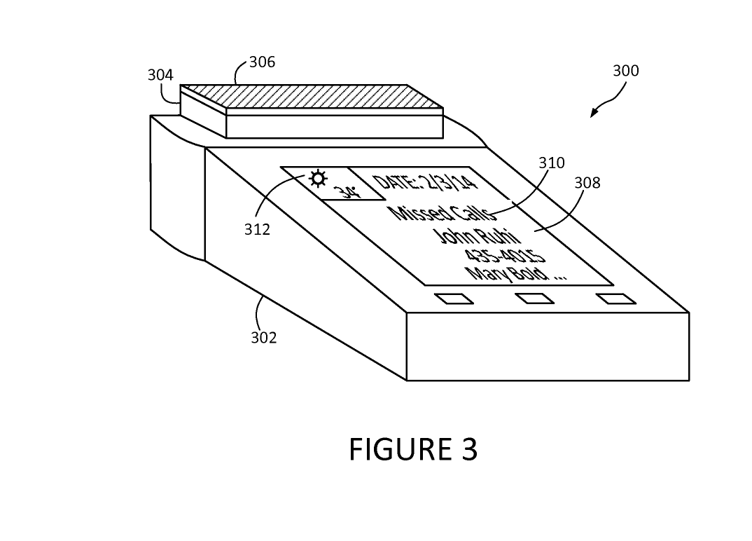

FIG. 3 shows an example integrated communication and/or computing device having a base unit and a mobile unit, usable in the network computing environment of FIG. 1. In various embodiments, Integrated Communication Device (ICD) 300 includes a base 302 having a screen 308 to display text 310 and graphic contents 312. ICD 300 may also include a handset 304 with a detachable back cover 306.

In various embodiments, ICD base 302 is a base computing device, similar in some respects to the computing device of FIG. 2, coupled with an external computer network, such as the Internet, via a network interface card. The ICD base may also be coupled to an external communication network such as a cell tower for wireless communications or a wired voice and/or data communication network, such as phone landlines like POTS (Plain Old Telephone Service). The ICD base may also be coupled with the handset 304 using a similar or different communication interface as the one used to couple to the external computer network. The ICD base may function as a central communication hub for one or more handsets 304 to relay communication data back and forth between a user using the handset and a remote user on a computer, phone, or other communication device. In various embodiments, ICD base 302 may have various types of user interface, to provide user control, such as a touch screen, a touchpad, a mouse, hardware buttons, software buttons, voice commands, pre-programmed or scheduled behavior, or a combination of one or more of the above.

In various embodiments, ICD base 302 includes display screen 308 that may be color or monochrome and is used to present text and graphical data. In some embodiments, the screen may be used to display local information to the user, such as phone numbers, names in a contact list, time, and various device settings like brightness level, sound level, and the like. In other embodiments, screen 308 may be used to display information from the internet in a web browser, such as news, calendars, weather information, company information, product information, or any other types of information available from various internet websites.

In various embodiments, handset 304 is an independent mobile computing and/or communication device in wireless communication with the ICD base 302, while in other embodiments, the handset provides a display and data input device extending at least some of the same functions of the ICD base to a mobile extension device. In some embodiments, the handset 304 includes a Removable External Component (REC) that is coupled with the handset in a mechanical or magnetic manner. The REC may be a protective, grip enhancing, and/or decorative back cover 306. It may also be a storage device like a NFC (Near Field Communication) drive, an input device like a touchpad, or any other external accessory or component that may be coupled with the handset to provide some function or service.

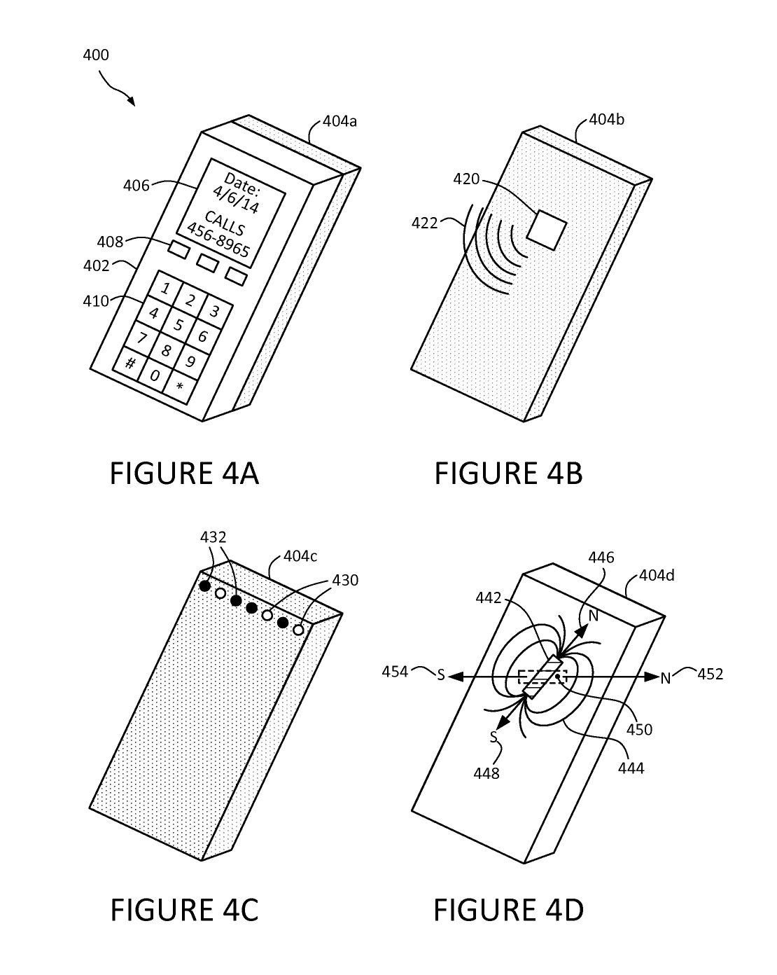

In various embodiments, the REC, such as the back cover 306 may be sensed by the handset 304, and distinguished from other RECs such as different versions of the back cover, using various techniques as further described below with respect to FIGS. 4A-4D. In response to the detection of the REC, the handset 304 may take a predetermined action and/or cause a predetermined action to be taken by the ICD 302. Such predetermined actions may be fixed actions or be further determined or modified based on other factors and information, as further described below. One such predetermined action is a change of UI (User Interface) and/or its characteristics. For example, after being triggered by a new REC that is coupled to the handset, the handset may cause a change in a color scheme of the UI. For instance, if a back cover with a color of green is attached to the handset, the handset detects the back cover and executes software steps to change the UI color scheme to green or to some other color different from the color scheme before the attachment of the back cover. Those skilled in the art will appreciate that a color scheme is not just a single color for a single element, but rather a combination of compatible colors, such as different shades of the same hue, that are applied to multiple graphic elements, such as window frames, buttons, fonts, background, and the like.

In various embodiments, once the handset is triggered by the detection of a new REC, any action may be taken in response. For example, an app (small software application) may be loaded and run to perform a specific task such as display a user name, change the display configuration to display different or more or less information by moving icons around or adding or deleting icons and other graphical elements. Such actions may affect the handset display or other behavior such as ringtone, brightness, and the like, or it may affect the ICD's behavior in a similar or different way, or both the handset and the ICD.

In various embodiments, the changes made or actions taken in response to the detection of the new REC may be further modified or affected by other information and elements. These other information may include a user identity, a user profile, date and/or time, or information obtained over the internet from a third party source such as database or a website. The user identity may be associated with a particular back cover color. For example, a particular user may be associated with a green back cover, while another particular user may be associated with a red back cover. The user profile may be generated based on data that are continuously obtained and saved by the handset and/or the ICD based on user activities, behavior, usage, and preferences over time such as level of brightness, color schemes, sound level, numbers most often called, websites most visited using the handset and/or the ICD, and the like. Date and time may also affect the changes made upon detection REC change. For example, one color scheme may be used at nights, and a different one during the day for better visibility under different lighting conditions or for esthetic reasons. Information obtained over the internet may include information related to the particular user from his website or another source that has information about the user. Advertisements that are suitable for the particular user associated with the back cover currently attached may be obtained from third party sources and displayed for the user.

In various embodiments, the software responsible for taking the predetermined actions may be an app installed by the user on the handset or the ICD, may be built into or preinstalled on the devices, or partly built-in and partly user-installed. For example, the detection part of the process, which detects the installation or attachment of the new REC and basic actions such as change of UI color may be built-in to the devices, while additional enhancements to the action may be installed as an app, other software components like software plug-ins, or configured by the user. The user configuration may be applicable to installed apps or to the built-in software.

In various embodiments, In various embodiments, the ICD 302 system may be implemented by a hardware and/or software system using one or more software components executing on the illustrative computing device of FIG. 2. One or more functions may be performed by each software module recorded on a medium such as an optical disk, magnetic tape, volatile or non-volatile computer memory, and the like, or transmitted by various communication techniques using various network and/or communication protocols, as described above with respect to FIG. 1. For example one or more separate software components may be used for each of the functions of the detection of a new REC attachment, removal of a REC, launching an app in response to the detection, configuring or modifying the user interface automatically based on the detected REC, and the like described herein. Those skilled in the art will appreciate that one function may implemented using multiple software modules or several functions may be implemented using one software module. With further reference to FIG. 2, these software modules are generally loaded into the memory module 206 of the computing device for execution.

FIGS. 4A-4D show examples of various detection techniques and mechanisms usable with the integrated communication device of FIG. 3 to detect a change of a cover component. FIG. 4A shows handset system 400 including handset 402 having hardware buttons 408, keypad 410, display screen 406, and back cover 404a. In various embodiments, handset 402 may be coupled with back cover 404a using various detection interfaces including mechanical or magnetic attachment methods. The detection of a new REC may be done via the detection interface using various techniques including electrical/signaling, mechanical, magnetic, optical, and any other suitable detection or sensing techniques. These techniques are further described below with respect to FIGS. 4B-4D. Those skilled in the art will appreciate that the handset system may be implemented in many forms with various features and is not limited to the embodiments described herein. For example, in various embodiments, the handset may not have one or more of hardware buttons, a display screen, and keypad. Alternatively, the handset may include other features not shown in these figures, such as a voice command interface for dialing numbers or displaying data on the handset screen or ICD screen.

FIG. 4B shows a back cover 404b having a signaling device 402 configured to generate an electromagnetic wave signal 422 to be detected by the handset 402, or if in close physical proximity of the ICD, be detected by the ICD. In various embodiments, an RFID (Radio Frequency IDentification) tag, an NFC tag or other NFC device, active or passive, a Bluetooth device, or other communication device may be used to generate the signal 422. In some embodiments, the signal serves as an identifier, which may then be used by the internal software installed or built into the handset or ICD, to determine what action to take. In other embodiments, the signal may contain more detailed data and information that specifies and/or directs the internal software of the handset or ICD to perform particular actions or types of actions. Such information may include an identification of the back cover (or REC, in general) in addition to other information such as what app to load, what the user name or ID is who is associated with the attached back cover, version information, authorization information to launch apps or change the UI, communication protocol, external website URI (Uniform Resource Identifier) to obtain additional information from external and/or remote sources, and the like.

FIG. 4C shows a back cover 404c having mechanical features such as holes and bumps 432 configured to create a mechanical signature by the unique combination of the holes and bumps, to be detected by the handset 402 when attached. In some embodiments, the holes and bumps represent 0's and 1's in a binary number. In other embodiments, predefined combinations of holes and bumps that are recognized as a particular ID for a back cover. The handset 402 may recognize the mechanical combination by having the same number of corresponding all holes or all bumps. When the back cover is attached to the handset, the corresponding mechanical features mate and depending on the state of the holes and bumps on the back cover, the combination of holes and bumps are detected. If the mechanical feature on both the handset and the back cover are the same, then the feature is considered as absent, but if they are different, that is, one hole and one bump, then they are mated together and the feature is considered detected.

FIG. 4D shows a back cover 404d having a magnet 442 oriented in a particular direction with respect to the back cover 404d, the magnet having a north pole 446, a south pole 448, generating a magnetic field 444. If the magnet is oriented in a different direction such as that shown by magnet 450 with north pole 452 and south pole 454, then a different magnetic field is generated, which amounts to a different magnetic signature. Such magnetic signatures can be detected by the handset 402 when the back cover 404d is attached. In various embodiments, one magnet may be used with a particular orientation, while in other embodiments, multiple magnets may be used to create different magnetic field signatures.

It will be understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A communication system comprising:
a base;
a handset wirelessly coupled with the base; and
a Removable External Component (REC) coupled with the handset, wherein the handset is configured to detect and distinguish different versions of the REC, and wherein the handset is further configured to change a User Interface (UI) of the communication system based on the detected version of the REC.

2. The communication system of claim 1, wherein at least one of the base and the handset includes a display screen configured to display information generated by the handset, the base, and/or external sources.

3. The communication system of claim 1, wherein the REC is a back cover having a color different from other back covers.

4. The communication system of claim 1, wherein the base is coupled with the internet and is configured to obtain and display information from external sources.

5. The communication system of claim 1, wherein the REC includes a Near Field Communication (NFC) device.

6. The communication system of claim 1, wherein the REC includes a Near Field Communication (NFC) device configured to indicate actions to be taken in response to detecting the REC.

7. The communication system of claim 1, wherein at least one of the handset and the base collect data about user actions and generate a user profile based on the collected data.

8. The communication system of claim 1, wherein the REC includes one of a mechanical and a magnetic interface configured to allow detection of the REC.

9. The communication system of claim 1, wherein the detection of the REC causes the UI to be changed based on a user profile generated from data collected by the handset.

10. A communication device configured to change a User Interface (UI), the device comprising:
a communication interface, configured to communicate with a communication base;
a detection interface configured to couple with a Removable External Component (REC); and
a UI modification module configured to modify the UI of the communication device based on a detection of a particular REC.

11. The communication device of claim 10, further comprising a detection module configured to detect a particular REC via the detection interface.

12. The communication device of claim 10, further comprising a display screen configured to display data from external sources.

13. The communication device of claim 10, wherein the detection interface includes one of an electrical, a mechanical, and a magnetic interface.

14. The communication device of claim 10, wherein a Near Field Communication (NFC) device is embedded in the REC and is configured to send a wireless signal to the handset to be detected and distinguished from other REC.

15. The communication device of claim 10, wherein an NFC embedded in the REC provides an indication to specify a type of action to be taken in response to the detection of the REC.

16. A method of changing User Interface (UI), the method comprising:
attaching a Removable External Component (REC) coupled with a communication handset via a detection interface;
detecting the REC via the detection interface using a detection module; and
changing the UI using a UI modification module.

17. The method of claim 16, further comprising collecting information about user activities to generate a user profile.

18. The method of claim 16, wherein the REC detection interface includes one of an electrical, mechanical, magnetic, and optical interfaces.

19. The method of claim 16, wherein detecting the REC via the detection interface comprises detecting an identifier generated by the REC.

20. The method of claim 16, wherein changing the UI comprises changing a color scheme of the UI.
